(19) United States
(12) Patent Application Publication
(10) Pub. No.: US 2008/0286191 A1
(43) Pub. Date: Nov. 20, 2008

(54) Process For The Production Of Highly Graphitizable Carbon Foam

(76) Inventors: Peter G. Stansberry, North Olmsted, OH (US); Irwin C. Lewis, Oberlin, OH (US)

Correspondence Address: WADDEY & PATTERSON, P.C., 1600 DIVISION STREET, SUITE 500, NASHVILLE, TN, 37203, US

(21) Appl. No.: 11/747,958

(22) Filed: May 14, 2007

(51) Int. Cl. C01B 31/04; C08J 9/00

(52) U.S. Cl. 423/448; 521/101

(57) ABSTRACT

A highly graphitizable carbon foam useful for, inter alia, battery components or high temperature applications, which includes a carbon foam produced from conventional mesophase pitch and a cross-linking agent like sulfur.

### BACKGROUND OF THE INVENTION

1. Technical Field

The present invention relates to a process for producing highly graphitizable carbon foam useful for applications including components of carbon foam batteries. More particularly, the present invention relates to carbon foams exhibiting both high thermal and electrical conductivities as well as improved graphitizability and density characteristics. The invention also includes the graphite foam.

2. Background Art

Carbon foams have attracted considerable recent activity because of their properties of low density, coupled with either very high or low thermal conductivity. Conventionally, carbon foams are prepared by two general routes. Highly graphitizable foams have been produced by thermal treatment of mesophase pitches under high pressure. These foams tend to have high thermal and electrical conductivities. For example, in Klett, U.S. Pat. No. 6,033,506, mesophase pitch is heated to approximately 50° C. to about 100° C. above the softening point while subjected to a pressure of 1000 pounds per square inch (psi) to produce an open-cell foam containing interconnected pores with a size range of 90-200 microns. According to Klett, after heat treatment to 2800° C., the solid portion of the foam develops into a highly crystalline graphitic structure with an interlayer spacing of 0.366 nm. The foam is asserted to have compressive strengths greater than previous foams (3.4 MPa or 500 psi for a density of 0.53 g/cc).

U.S. Pat. No. 6,399,149, Klett et al. describes a process for producing carbon foam without the need for conventional oxidative stabilization. Pitch is placed in a mold under vacuum and heated to approximately 50° C. to about 100° C. above the softening point of the pitch to coalesce the pitch. The pitch mixture is then pressurized to 1000 psi (6.9 MPa) or higher with an inert gas, followed by heating of the pitch. Gases are evolved from the pitch that are sufficient to foam the pitch at 1000 psi (6.9 MPa). Generally the graphene layer spacing of the graphitized foam was determined to be about 0.336 nanometers.

In Hardcastle et al. (U.S. Pat. No. 6,776,936) carbon foams with densities ranging from 0.678-1.5 g/cm³ are produced by heating pitch in a mold at pressures up to 30,000 psi (206 MPa), and then partially reducing the pressure to induce foaming. The foamed pitch is stabilized by heating while still under pressure. The foam is alleged to be highly graphitizable, with a resulting thermal conductivity of about 250 W/m.K.

According to H. J. Anderson et al. in Proceedings of the 43^{rd} International SAMPE Meeting, p. 756 (1998), carbon foam is produced from mesophase pitch followed by oxidative thermosetting and carbonization to 900° C. The foam has an open cell structure of interconnected pores with varying shapes and with pore diameters ranging from 39 to greater than 480 microns.

Rogers et al., in Proceedings of the 45^{th} SAMPE Conference, pg 293 (2000), describe the preparation of carbon foams from coal-based precursors by heat treatment under high pressure to give materials with densities of 0.35-0.45 g/cc with compressive strengths of 2000-3000 psi (thus a strength/density ratio of about 6000 psi/(g/cc)). These foams have an open-celled structure of interconnected pores with pore sizes ranging up to 1000 microns. Unlike the mesophase pitch foams described above, they are not highly graphitizable. In a recent publication, the properties of this type of foam were described (High Performance Composites September 2004, p. 25). The foam has a compressive strength of 800 psi at a density of 0.27 g/cc or a strength to density ratio of 3000 psi/(g/cc).

Kearns, U.S. Pat. No. 5,868,974 describes a process for the preparation of a pitch foam including the heat treatment of milled pitch at pressures between 1000 and 1500 psi (6.9 and 10.3 MPa), partially reducing the pressure to induce foaming, and the stabilization of the resultant foam in a forced-air oven at approximately 150° C. to about 200° C. until 5 to about 10 percent weight gain is achieved.

Stiller et al. (U.S. Pat. No. 5,888,469) describes production of carbon foam by pressure heat treatment of hydrogenated or solvent extracted coal. These materials are claimed to have high compressive strengths of 600 psi for densities of 0.2-0.4 gm/cc (strength/density ratio of from 1500-3000 psi/(g/cc)). It is suggested that these foams are stronger than those having a glassy carbon or vitreous nature which are not graphitizable.

Carbon foams can also be produced by direct carbonization of polymers or polymer precursor blends. Mitchell, in U.S. Pat. No. 3,302,999, discusses preparing carbon foams by heating a polyurethane polymer foam at 200-255° C. in air followed by carbonization in an inert atmosphere at 900° C. These foams have densities of 0.085-0.387 g/cc and compressive strengths of 130 to 2040 psi (ratio of strength/density of 1529-5271 psi/(g/cc)).

In U.S. Pat. No. 5,945,084, Droege described the preparation of open-celled carbon foams by heat treating organic gels derived from hydroxylated benzenes and aldehydes (phenolic resin precursors). The foams have densities of 0.3-0.9 g/cc and are composed of small mesopores with a size range of 2 to 50 nm.

Mercuri et al. (Proceedings of the 9^{th} Carbon Conference, pg. 206 (1969)) prepared carbon foams by pyrolysis of phenolic resins. For foams with a density range of 0.1-0.4 g/cc, the compressive strength to density ratios were from 2380-6611 psi/(g/cc). The pores were ellipsoidal in shape with pore diameters of 25-75 microns for a carbon foam with a density of 0.25 g/cc.

Stankiewicz (U.S. Pat. No. 6,103,149) prepares carbon foams with a controlled aspect ratio of 0.6-1.2. The patentee points out that users often require a completely isotropic foam for superior properties with an aspect ratio of 1.0 being ideal. An open-celled carbon foam is produced by impregnation of a polyurethane foam with a carbonizing resin followed by thermal curing and carbonization. The pore aspect ratio of the original polyurethane foam is thus changed from 1.3-1.4 to 0.6-1.2.

Unfortunately, carbon foams produced by many prior art processes utilize a synthetic form of mesophase pitch and require both very high pressures and long process times. The foams generally available require the use of complex stabilization and thermosetting processes for the creation of the prior art foams. In addition, many prior art polymer-based carbon foams do not exhibit desirable interlayer spacing and a crystalline size value making them ill-suited for applications requiring thermal or electrical conductivity.

What is desired, therefore, is a process for creating a highly graphitizable carbon foam which does not require the use of very high pressures and long processing times. Indeed, a combination of characteristics, including less expensive processing parameters and precursors have been found to be ideal for creating a highly graphitizable carbon foam. Also desired is graphite foam produced from the highly graphitizable carbon foam.

### SUMMARY OF THE INVENTION

An object of the invention therefore is a process for producing a highly graphitizable carbon foam having characteristics which enable it to be employed in applications requiring both high thermal and electrical conductivities.

Another object of the invention is a process for producing carbon foam from conventional mesophase pitch.

Still another object of the invention is a process for producing highly graphitizable carbon foam utilizing sulfur without decreasing the graphitizability of the mesophase pitch.

Yet another object of the invention is a process for producing highly graphitizable carbon foam which includes shorter periods of increased pressure and temperature in producing the desired highly graphitizable carbon foam.

Another object of the invention is a graphitized foam produced from graphitizing the highly graphitizable carbon foam created from the inventive process.

These aspects and others that will become apparent to the artisan upon review of the following description can be accomplished by providing a method for preparing a highly graphitizable carbon foam, comprising combining mesophase pitch and a cross-linking agent to form a cross-linking agent-mesophase pitch mixture; and treating the cross-linking agent-mesophase pitch mixture to form a graphitizable carbon foam.

The pitch used is conventional mesophase pitch preferably derived from either coal tar or petroleum and combining the mesophase pitch with of from about 2 percent to about 10 percent by weight of a cross-linking agent, preferably sulfur, to produce the highly graphitizable carbon foam. The inventive process may be utilized to produce graphitized foam having an layer spacing of between about 3.354 Angstroms and 3.365 Angstroms with a crystallite size value of greater than about 500 Angstroms. The foam should also exhibit greater than about 90 percent and preferably closer to 100 percent anisotropy in the solid portions as determined by polarized-light microscopy. Generally, large anisotropic domain sizes should be present in excess of 200 microns and preferably greater than about 300 microns.

It is to be understood that both the foregoing general description and the following detailed description provide embodiments of the invention and are intended to provide an overview or framework of understanding to the nature and character of the invention as it is claimed.

### BRIEF DESCRIPTION OF THE DRAWING

FIG. 1 is a 200× photomicrograph of graphitized foam formed from the highly graphitizable carbon foam of the present invention.

### DETAILED DESCRIPTION OF THE PREFERRED EMBODIMENTS

The present invention provides a process for creating a graphitic carbon foam which is uniquely capable of use in applications necessitating a high thermal and/or electrical conductivity. The inventive process exhibits process parameters and process precursors to provide highly graphitizable carbon foam. In addition, the highly graphitizable carbon foam produced by the novel process can be graphitized to produce graphite foam.

More particularly, the inventive process for creating highly graphitizable carbon foam includes the use of mesophase pitch which may be derived from either coal tar, petroleum, or model compounds. Generally the mesophase pitch contains from about 60% to about 100% mesophase and preferably from about 90% to about 100% mesophase and is derived from coal tar or petroleum. Additionally, the mesophase pitch used for the inventive process advantageously has a Modified Conradson Carbon (MCC) content of from about 90% to about 99% and a Mettler softening point of from about 280° C. to about 330° C. Coal tar or petroleum is the preferred precursor for mesophase pitch because of their high aromaticity, and also because they are more economical when compared to the synthetic mesophase pitches often required in prior art processes. Conversely, the use of a mesophase pitch created from the catalytic polymerization of a condensed polycyclic aromatic hydrocarbon such as naphthalene through the use of HF-BF₃ is also within the contemplation of the invention, although the high cost of such pitches may be prohibitive.

The inventive process for producing highly graphitizable carbon foam should include the combination of a cross-linking agent with the mesophase pitch. Suitable cross-linking agents include sulfur, quinone, oxidizing agents like (NH₄)₂S₂O₃, NaClO₃, oxygen, chlorates, dichromates, persulfates and inorganic carbenes such as SnCl₂ and PbCl₂; sulfur is preferred. The addition level of the cross-linking agent should be from about 1% to about 10% and more preferably of from about 4% to about 6% of the total weight of the cross-linking agent/mesophase pitch mixture.

Advantageously, the pressures employed during the reaction of cross-linking agent with pitch are lower than those conventionally employed. More specifically, pressures of about 500 psi (3.5 MPa) or lower are suitable for effective reaction. Indeed, pressures no more than about 100 psi (0.7 MPa) can be employed. Desirably, the processing pressure can be as low as atmospheric and is more preferably no less than about 30 psi (0.2 MPa). Moreover, the process of the present invention can operate at a constant pressure. In other words, where prior art processes require a pressurization step for the reaction followed by depressurization to permit foaming (while still at a pressure significantly higher than that of the present invention), the present invention does not require such a depressurization step. The foaming pressure can be the same as the reaction pressure. An additional advantage of processing in this manner, where pressures are not reduced until after foaming, is that cell size of the resulting foam can be controlled to a greater degree.

By heating under pressure, as noted above, the cross-linking agent reacts with the pitch and provides for cross-linking of the aromatic rings by removal of a pendant hydrogen on each ring and bonding with an element from the cross-linking agent to form a functional byproduct. In the case of sulfur, H₂S is generated. This functional byproduct acts to generate foaming, and furthermore, also acts as a thermal setting agent for the pitch so that complex stabilization and thermosetting processes of the prior art are not needed.

The process of transforming the mesophase pitch/cross-linking agent mixture to carbon foam is preferably carried out in a single stage using relatively low pressures of less than about 500 psi, preferably from about 30 psi to about 100 psi, and more preferably from about 40 psi to about 60 psi. Additionally, the reactor containing the mesophase pitch/cross-linking agent mixture heats at a rate of from about 80° C. per hour to a rate of about 120° C. per hour, reaching a maximum maintained temperature of from about 500° C. to about 650° C.

The inventive process additionally includes the subsequent baking of the pitch foam to yield a highly graphitizable carbon foam. The carbon foam may then be graphitized at a temperature of from about 2800° C. to about 3200° C. to obtain a graphite foam with a density of from about 0.10 g/cc to about 0.6 g/cc. Furthermore, the graphite foam may have a specific resistivity at room temperature of from about 30 micro-ohm-meters to about 200 micro-ohm-meters.

Advantageously, the graphitized foam produced from the carbon foam created by the inventive process may have an interlayer spacing of from about 3.354 to about 3.365 Angstroms and preferably of from about 3.354 Angstroms to about 3.358 Angstroms and may have a crystallite size value of greater than about 500 Angstroms and preferably greater than about 1000 Angstroms.

In a preferred embodiment, highly graphitizable carbon foams in accordance with the present invention are derived from such carbonaceous starting materials as mesophase pitch derived from either coal tar or petroleum. Generally, mesophase pitch can be prepared from feed stock such as heavy aromatic petroleum streams, ethylene cracker tars, coal derivatives, petroleum thermal tars, fluid cracker residues, and pressure-treated aromatic distillates having a boiling range from about 340° C. to about 520° C. The production of mesophase pitch is described in, for example, U.S. Pat. No. 4,017,327 to Lewis et al., the disclosure of which is incorporated herein by reference. Typically, mesophase pitch is formed by heating the feed stock in a chemically inert atmosphere (such as nitrogen, argon, neon, helium or the like) to a temperature of about 350° C. to about 500° C. A chemically inert gas can be bubbled through the feed stock during heating to facilitate the formation of mesophase pitch. In doing so, lighter molecular weight species are removed in conjunction with the free radical reaction of small aromatic rings which form polyaromatic molecules.

Preferably, the mesophase pitch forming the highly graphitizable carbon foam is either petroleum or coal tar-derived mesophase pitch and preferably has a viscosity of from about 0.1 poise to about 5 poise at a temperature of from about 140° C. to about 260° C. In a preferred embodiment, the mesophase pitch contains about 0.02 weight percent ash, has an MCC value of from about 90% to about 100%, a Mettler softening point of from about 300° C. to about 350° C., and a sulfur weight percent of from about 0.2% to about 0.3%.

The cross-linking agent preferably employed in the inventive process is sulfur. The sulfur utilized in combination with the mesophase pitch is generally elemental sulfur and is added in an amount equal to about 1% by weight to about 10% by weight, more preferably from about 4% to about 6% by weight, of the combined mesophase pitch/sulfur mixture. The sulfur additive reacts with the mesophase pitch to generate hydrogen sulfide gas which assists in generating foaming. Additionally, the sulfur acts as a thermosetting agent to the mesophase pitch so that complex stabilization and thermosetting processes of the prior art are not needed.

The reaction of sulfur with conventional non-mesophase pitch to induce thermosetting with the generation of hydrogen sulfide is known within the art. However, the sulfur reaction drastically reduces the graphitizability of the derived carbonized product. For example, in U.S. Pat. No. 5,413,738 to Lewis et al., non-graphitizing carbons are prepared by the reaction of coal tar based precursors with sulfur. Additionally, in the paper by I. C. Lewis in the International Carbon Conference, Strasbourg, 1998, V1, pp 39-40, the reaction of sulfur with coal tar derived materials is presented to produce a completely non-graphitizing glassy-type carbon similar to that obtained with phenolic resins. After heat treatment of these prior art carbons to about 3000° C., the sulfur treated coal tar products have an interlayer spacing on the order of about 3.4 Angstroms or higher, and additionally, show little or no anisotropy. Thus, the use of sulfur would be expected to lead to a non-graphitizing carbon with low electrical or thermal conductivity.

Surprisingly, when sulfur is added to mesophase pitch, both thermal setting and hydrogen sulfide release occur but without decreasing the graphitizability of the mesophase pitch. Without being bound to any particular theory, the coal tar mesophase pitch appears to have planar aromatic molecular components which are sufficiently large in size and thus carbonized to form graphitic structures which retain their planar order despite the inclusion of elemental sulfur in the initial carbon foam precursors.

Generally, the elemental sulfur and conventional mesophase pitch are combined together to form a sulfur/mesophase pitch mixture. Preferably, the mesophase pitch comprises of from about 60% to about 100% mesophase, and more preferably, of from about 90% to about 100% mesophase. Advantageously, sulfur is contained within the sulfur mesophase pitch mixture at a weight percent of from about 1% to about 10% sulfur, and more preferably, of from about 4% to about 6% sulfur. In a preferred embodiment, the sulfur mesophase pitch mixture is sealed within a pressure vessel at a pressure less than 500 psig, preferably from about 30 psig to about 100 psig, and more preferably, of from about 40 psig to about 60 psig. In another embodiment, the pitch/sulfur mixture can be left at pressures less than 15 psig, or even at atmospheric pressure.

The sulfur mesophase pitch mixture is then heated to about 450° C. to about 690° C. at a rate of from about 80° C. to about 120° C. per hour with a sustained soak period at the final temperature of approximately five hours in one embodiment, or a time sufficient to maintain a self-supporting foam structure.

The resulting product is a “green” foam, that is, a foam which may still contain amounts of volatile matter. The green foam may be subsequently baked at a temperature of about 700° C. to about 900° C. at a rate of from about 40° C. to about 80° C. per hour with a soak period at the final temperature of from about one to four hours. This baking procedure of the green foam produces highly graphitizable carbon foam which may be subsequently graphitized to produce a graphitized foam product. Typically, the yield of the highly graphitizable carbon foam from the green foam precursor is about 90% to about 98% by weight.

In order to convert the highly graphitizable carbon foam to graphitized foam, the carbon foam may be graphitized by heating to a temperature of about 2800° C. to about 3100° C. and more preferably at about 3000° C. in an air-excluded atmosphere such as in the presence of nitrogen or argon. The heating rate should be controlled such that the carbon foam is brought to the desired temperature and maintained for the graphitization to occur.

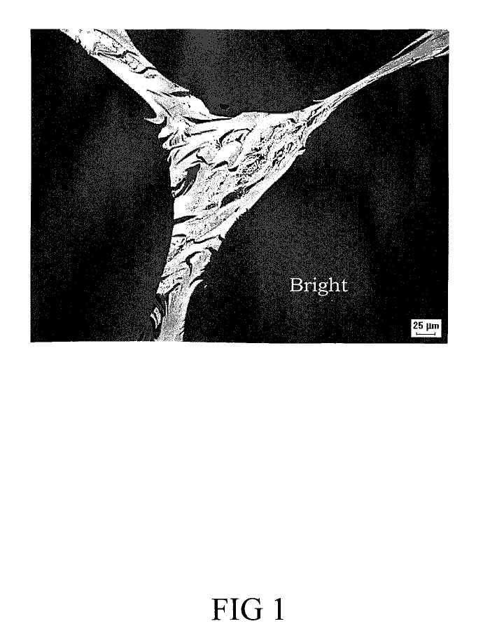

The resulting graphite foam created from the highly graphitizable carbon foam has a d-spacing of from about 3.354 Angstroms to about 3.365 Angstroms where the d-spacing is the spacing of the atomic layers parallel to the graphite crystal and also is termed “interlayer spacing.” As known in the art, a perfect graphitic structure possesses an interlayer spacing of 3.354 Angstroms with the graphitized foam produced from the highly graphitizable carbon foam having a near perfect spacing with the preferred interlayer spacing of the graphite foam created from the highly graphitizable carbon foam being of from about 3.354 Angstroms to about 3.358 Angstroms. Generally, the crystallite size value is greater than about 500 Angstroms and preferably greater than about 1000 Angstroms and is measured from the half width of a graphite peak using standard x-ray diffraction techniques. Furthermore, the graphitic foam exhibits greater than about 90% and preferably about 100% anisotropy in the solid portion, as determined by polarized-light microscopy, with large anisotropic domain sizes in excess of about 200 microns and preferably in excess of 300 microns. The graphitic foam can have a resistivity of about 200 micro-ohms-meters or less, down to even about 30 micro-ohms-meters, or even less, and a density of about 0.1 grams/cubic centimeter (g/cc) to about 0.6 g/cc. FIG. 1 illustrates a polarized photomicrograph of graphitized foam created from the highly graphitizable carbon foam of the present application. The photomicrograph of FIG. 1 is a 200× magnification of the graphitized foam made using the high graphitizable carbon foam of the present invention having about four weight percent sulfur.

In order to further illustrate the principles and operation of the present invention, the following example is provided. However, this example should not be taken as limiting in any regard.

### EXAMPLE

A coal tar-based mesophase pitch with an MCC weight percent of about 97% and a Mettler softening point of about 312° C. is ground to pass through a Tyler 40 mesh sieve. Sufficient elemental sulfur is added to provide for about four weight percent sulfur based on the mass of the mesophase pitch. Approximately 9 grams of elemental sulfur is added to 230 grams of mesophase pitch. About 190 grams of the pitch and sulfur mixture is placed in a 10 cm high by 15 cm wide by 19 cm long aluminum pan with the height of the pitch/sulfur bed being approximately 1.75 cm. The pan is sealed in a pressure vessel, and subsequently purged of air by nitrogen. The reactor with the pitch/sulfur mixture is pressurized to approximately 50 psig and is maintained at that approximate pressure throughout the duration of the foaming process.

The mixture is heated at about 100° C. per hour to 570° C. and held for about five hours at that temperature. The foam is allowed to cool to room temperature, and then the pressure is released. The resultant green foam has a yield of approximately 94.5 weight percent and a swelling ratio defined as the height of the green foam divided by the height of the initial bed of approximately 4.

The green foam is then heated under an argon purge at a rate of 60° C. per hour to about 850° C., and maintained at about 850° C. for about two hours. The resultant highly graphitizable foam exhibits a baked yield of about 95.4 weight percent.

The highly graphitizable carbon foam is then graphitized at about 3000° C. under a argon purge thus providing a graphitized foam product with a density of about 0.18 g/cm³ and a specific resistivity of about 48 micro-ohms-meters. An x-ray diffraction analysis is used to determine the interlayer spacing, the d-spacing, which is approximately 3.359 Angstroms showing that the graphitized foam product exhibits a nearly perfect graphite crystal arrangement. The L_{C} crystallite size value is approximately 1100 Angstroms and is measured from the high width of the 002 graphite peak using standard x-ray diffraction techniques.

The highly graphitizable carbon foam is unique as compared to other carbon foams in that a mesophase pitch is combined with sulfur to provide a highly graphitizable carbon foam. Furthermore, the highly graphitizable carbon foam may produce a graphitic foam product having a specific resistivity of less than about 200 micro-ohm-meters. Yet furthermore, the graphitic foam produced from the highly graphitizable carbon foam may exhibit greater than about 90% anisotropy and preferably closer to 100% anisotropy in the solid portion when observed using polarized light microscopy.

Accordingly, in the present invention is presented a process for producing highly graphitizable carbon foams having characteristics heretofore not achievable using methods known in the art. The carbon foams produced from the novel processes provide for a graphitic product having highly crystalline graphite characteristics while requiring lower pressures, shorter process times, and less expensive ingredients in the production thereof.

The disclosures of all cited patents and publications referred to in this application are incorporated herein by reference.

The above description is intended to enable the person skilled in the art to practice the invention. It is not intended to detail all of the possible variations and modifications that will become apparent to the skilled worker upon reading the description. It is intended, however, that all such modifications and variations be included within the scope of the invention that is defined by the following claims. The claims are intended to cover the indicated elements and steps in any arrangement or sequence that is effective to meet the objectives intended for the invention, unless the context specifically indicates the contrary.

What is claimed is:

1. A method for preparing a highly graphitizable carbon foam, comprising:
a. combining mesophase pitch and a cross-lining agent to form a cross-linking agent-mesophase pitch mixture; and
b. treating the cross-linking agent-mesophase pitch mixture to form a graphitizable carbon foam.

2. The method of claim 1 wherein the cross-linking agent is selected from the group consisting of sulfur, quinone, oxidizing agents, inorganic carbenes, and mixtures thereof.

3. The method of claim 2 wherein the cross-linking agent comprises (NH₄)₂S₂O₃, NaClO₃, oxygen, chlorates, dichromates, persulfates, or mixtures thereof.

4. The method of claim 2 wherein the cross-linking agent comprises SnCl₂ and PbCl₂, or mixtures thereof.

5. The method of claim 2 wherein the cross-linking agent comprises sulfur.

6. The method of claim 5 wherein step b) further comprises the steps of:
b1) pressurizing the sulfur-mesophase pitch mixture to form a pressurized sulfur-mesophase pitch mixture;
b2) heating the pressurized sulfur-mesophase pitch mixture to a temperature of from about 450° C. to about 690° C. to form a heated, pressurized sulfur-mesophase pitch mixture;
b3) baking the green foam to form the graphitizable carbon foam.

7. The method of claim 5 wherein step b) further comprises the steps of:
b1) heating the pressurized sulfur-mesophase pitch mixture at atmospheric pressure to a temperature of from about 450° C. to about 690° C. to form a heated sulfur-mesophase pitch mixture;
b2) baking the green foam to form the graphitizable carbon foam.

8. The method of claim 1 wherein the mesophase component of the pitch comprises of from about 60% to about 100% of the pitch.

9. The method of claim 8 wherein the mesophase component of the pitch comprises of from about 90% to about 100% of the pitch.

10. The method of claim 1 wherein the mesophase pitch is derived from coal tar.

11. The method of claim 1 wherein the mesophase pitch is derived from petroleum.

12. The method of claim 5 wherein the sulfur-mesophase pitch mixture comprises of from about 1% to about 10% sulfur.

13. The method of claim 12 wherein the sulfur-mesophase pitch mixture comprises of from about 4% to about 6% sulfur.

14. The method of claim 1 wherein in step b) the sulfur-mesophase pitch mixture is pressurized to a pressure of no greater than about 500 psi.

15. The method of claim 14 wherein the sulfur-mesophase pitch mixture is pressurized to a pressure of at from about 30 psi to about 100 psi.

16. A method for preparing a graphite foam, comprising:
a. combining mesophase pitch and sulfur to form a sulfur-mesophase pitch mixture;
b. treating the sulfur-mesophase pitch mixture to form a graphitizable foam; and
c. heating the graphitizable carbon foam to create conductive graphite foam.

17. The method of claim 16 wherein step c) comprises baking the graphitizable carbon foam at a temperature of from about 2800° C. to about 3100° C.

18. The method of claim 16 wherein the conductive graphite foam of step c) comprises an interlayer spacing of from about 3.354 Angstroms to about 3.365 Angstroms.
